(19) United States
(12) Patent Application Publication
(10) Pub. No.: US 2003/0031178 A1
(43) Pub. Date: Feb. 13, 2003

(54) Method for ascertaining network bandwidth allocation policy associated with network address

(75) Inventors: Ali Haeri, Sunnyvale, CA (US); Li-Ho Raymond Hou, Saratoga, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: AMPLIFY.NET, INC.

(21) Appl. No.: 09/924,198

(22) Filed: Aug. 7, 2001

(51) Int. Cl. H04L 12/56

(52) U.S. Cl. 370/392; 370/412

(57) ABSTRACT

A network comprises a local group of network workstations and clients that periodically need access to a wide area network like the Internet. A class-based queue traffic shaper is placed in between and enforces multiple service-level agreement policies on individual connection sessions by limiting the maximum data throughput for each connection. The class-based queue traffic shaper distinguishes amongst datapackets according to their respective source and/or destination IP-addresses. Which policy is appropriate to enforce is found by placing all IP-addresses with policies attached to them into an ordered list of three-byte segment numbers. The least significant byte of an IP-address is dropped to form a segment number. Classification then depends on finding the IP-address in a datapacket to the ordered list of segment numbers. If a match occurs, an index lookup table for the respective segment allows the least-significant fourth byte of the IP-address to point to the bandwidth policy to use.

### BACKGROUND OF THE INVENTION

1. Field of the Invention

The invention relates generally to computer network protocols and equipment for adjusting packet-by-packet bandwidth according to the source and/or destination IP-addresses of each such packet. More specifically, the present invention relates to software program methods that can eliminate the need for expensive content-addressable memory (CAM), and software program methods for making bandwidth-policy look-up subroutines quick and deterministic.

2. Description of the Prior Art

Access bandwidth is important to Internet users. New cable, digital subscriber line (DSL), and wireless “always-on” broadband-access together are expected to eclipse dial-up Internet access by 2001. So network equipment vendors are scrambling to bring a new generation of broadband access solutions to market for their service-provider customers. These new systems support multiple high speed data, voice and streaming video Internet-protocol (IP) services, and not just over one access media, but over any media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad,” it is always “shared” at some point and the total bandwidth is not unlimited. All broadband pipes must therefore be carefully and efficiently managed.

Internet Protocol (IP) packets are conventionally treated as equals, and therein lies one of the major reasons for its “log jams”. When all IP-packets have equal right-of-way over the Internet, a “first come, first serve” service arrangement results. The overall response time and quality of delivery service is promised to be on a “best effort” basis only. Unfortunately all IP-packets are not equal, certain classes of IP-packets must be processed differently.

In the past, such traffic congestion has caused no fatal problems, only an increasing frustration from the unpredictable and sometimes gross delays. However, new applications use the Internet to send voice and streaming video IP-packets that mix-in with the data IP-packets. These new applications cannot tolerate a classless, best efforts delivery scheme, and include IP-telephony, pay-per-view movie delivery, radio broadcasts, cable modem (CM), and cable modem termination system (CMTS) over two-way transmission hybrid fiber/coax (HFC) cable.

Internet service providers (ISPs) need to be able to automatically and dynamically integrate service subscription orders and changes, e.g., for “on demand” services. Different classes of services must be offered at different price points and quality levels. Each subscriber's actual usage must be tracked so that their monthly bills can accurately track the service levels delivered. Each subscriber should be able to dynamically order any service based on time of day/week, or premier services that support merged data, voice and video over any access broadband media, and integrate them into a single point of contact for the subscriber.

There is an urgent demand from service providers for network equipment vendors to provide integrated broadband-access solutions that are reliable, scalable, and easy to use. These service providers also need to be able to manage and maintain ever growing numbers of subscribers.

Conventional IP-addresses, as used by the Internet, rely on four-byte hexadecimal numbers, e.g., 00H-FFH. These are typically expressed with four sets of decimal numbers that range 0-255 each, e.g., “192.55.0.1”. A single look-up table could be constructed for each of 4,294,967,296 (256⁴) possible IP-addresses to find what bandwidth policy should attach to a particular datapacket passing through. But with only one byte to record the policy for each IP-address, that approach would require more than four gigabytes of memory. So this is impractical.

There is also a very limited time available for the bandwidth classification system to classify a datapacket before the next datapacket arrives. The search routine to find which policy attaches to a particular IP-address must be finished within a finite time. And as the bandwidths get higher and higher, these search times get proportionally shorter.

Content-addressable memory (CAM) has been used in conventional systems, but when the search key is four bytes wide (32-bits), a very expensive large array of CAM is needed. So while CAM performs well in real-time, its costs are prohibitive in all but the most exotic of applications.

### SUMMARY OF THE PRESENT INVENTION

It is therefore an object of the present invention to provide a system and method for controlling network bandwidth at a local site according to a predetermined policy.

It is another object of the present invention to provide method of quickly and deterministically attaching a bandwidth policy to a datapacket according to its source and/or destination IP-address.

Briefly, a network embodiment of the present invention comprises a local group of network workstations and clients that periodically need access to a wide area network like the Internet. A class-based queue traffic shaper is placed in between and enforces multiple service-level agreement policies on individual connection sessions by limiting the maximum data throughput for each connection. The class-based queue traffic shaper distinguishes amongst datapackets according to their respective source and/or destination IP-addresses. Which policy is appropriate to enforce is found by placing all IP-addresses with policies attached to them into an ordered list of three-byte segment numbers. The least significant byte of an IP-address is dropped to form a segment number. A segment look-up list may be loaded into a content-addressable memory (CAM). Classification then depends on finding the IP-address in a datapacket to the ordered list of segment numbers. If a match occurs, an index lookup table for the respective segment allows the least-significant fourth byte of the IP-address to point to the bandwidth policy to use.

An advantage of the present invention is a system and method are provided to detect and favor with increased bandwidth any packets transmitted and received by local clients and servers.

A still further advantage of the present invention is a bandwidth allocation system is provided that prioritizes packet transfers according to service-level agreement policies.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a functional block diagram of a bandwidth allocation system embodiment of the present invention with a gateway to the Internet;

FIG. 2 is a flowchart of a class-based queue method embodiment of the present invention that checks to see if particular datapackets can be sent through immediately or must be buffered to stay within allowed bandwidth parameters;

FIG. 3 is a flowchart of a class-based queue method embodiment of the present invention that checks to see if additional bandwidth is available;

FIG. 4 is a flowchart of a class-based queue processing method embodiment of the present invention that checks to see if particular datapackets can be sent through immediately or must be buffered to stay within allowed bandwidth parameters;

FIG. 5 is a flowchart of a method embodiment of the present invention for defining user bandwidth parameters;

FIG. 6 is a drawing that represents the plurality of user virtual pipes that can co-exist within a single physical fiber-optic cable in an embodiment of the present invention;

FIG. 7 is a functional block diagram of a class-based queue traffic shaper embodiment of the present invention similar to the one shown in FIG. 1; and

FIG. 8 is a block diagram representing a memory organization embodiment of the present invention in which all possible four-byte IP-addresses are truncated into their corresponding three-byte segment numbers and recorded in a sorted list.

### DETAILED DESCRIPTION OF THE PREFERRED EMBODIMENTS

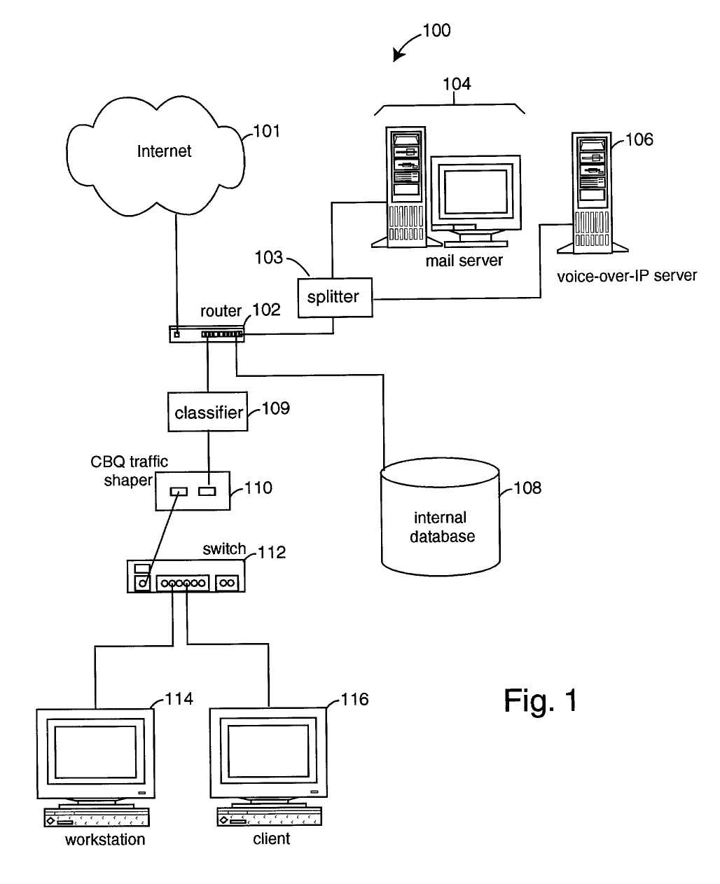

FIG. 1 illustrates a network embodiment of the present invention, and is referred to herein by the general reference numeral 100. The Internet 101 or other wide area network (WAN) is accessed through a network router 102. A bandwidth splitter 103 dynamically aggregates the demands for bandwidth presented by an e-mail server 104 and a voice-over-IP server 106 through the router 102. A local database 108 is included, e.g., to store e-mail and voice messages.

An IP-address/port-number classifier 109 monitors packet traffic passing through to the router 102, and looks into the content of messages to discern temporary address and port assignments being erected by a variety of application programs. A class-based queue (CBQ) traffic shaper 110 dynamically controls the maximum bandwidth for each connection through a switch 112 to any workstation 114 or any client 116. A similar control is included in splitter 103. The IP-address/port-number classifier 109 sends control packets over the network to the CBQ traffic shaper 110 that tell it what packets belong to what applications. Policies are used inside the CBQ traffic shaper 110 to monitor and limit every connection involving an IP-address behind the switch 112. A preferable exception is to allow any workstation 114 or any client 116 practically unlimited access bandwidth to their own local e-mail server 104 and voice-over-IP server 106. Such exception is handled as a policy override.

The separation of the IP-address/port-number classifier 109 and CBQ traffic shaper 110 into separate stand-alone devices allows independent parallel processors to be used in what can be a very processor-intensive job. Such separation further allows the inclusion of IP-address/port-number classifier 109 as an option for which an extra price can be charged. It could also be added in later as part of a performance upgrade. The packet communication between the IP-address/port-number classifier 109 and CBQ traffic shaper 110 allows some flexibility in the physical placement of the respective units and no special control wiring in between is necessary.

The policies are defined and input by a system administrator. Internal hardware and software are used to spool and despool packet streams through at the appropriate bandwidths. In business model implementations of the present invention, subscribers are charged various fees for different levels of service, e.g., better bandwidth and delivery time-slots. For example, the workstations 114 and clients 116 could be paying customers who have bought particular levels of Internet-access service and who have on-demand service needs. One such on-demand service could be the peculiar higher bandwidth and class priority needed to support an IP-telephone call. A use-fee or monthly subscription fee could be assessed to be able to make such a call.

If the connection between the WAN 101 and the router 102 is a digital subscriber line (DSL) or other asymmetric link, the CBQ traffic shaper 110 is preferred to have a means for enforcing different policies for the same local IP-addresses transmit and receive ports.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of packet can be limited to a different connection-bandwidth than another session-connection involving a second type of packet. The SLA policies are attached to each and every local IP-address, and any connection-combinations with outside IP-addresses can be ignored.

In alternative embodiments, the CBQ traffic shaper 110 is configured so that its SLA policies are such that any policy-conflicts between local IP-address transfers are resolved with a lower-speed one of the conflicting policies taking precedence. The CBQ traffic shaper is configured so its SLA policies are dynamically attached and readjusted to allow any particular on-demand content delivery to the local IP-addresses.

The data passed back and forth between connection partners during a session must be tracked by the CBQ traffic shaper 110 if it is to have all the information needed to classify packets by application. Various identifiable patterns will appear that will signal new information. These patterns are looked for by an IP-address/port-number classifier that monitors the datapacket exchanges. Such IP-address/port-number classifier is preferably included within the CBQ traffic shaper 110. An automatic bandwidth manager (ABM) is also included that controls the throughput bandwidth of each user by class assignment.

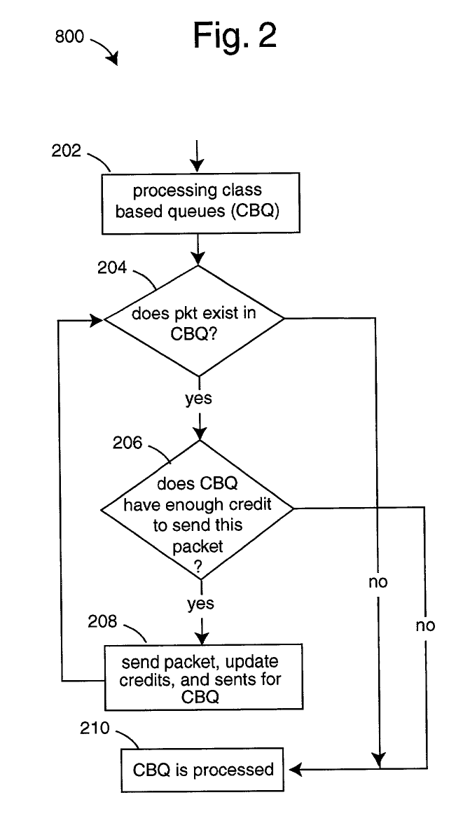

FIG. 2 illustrates a class-based queue processing method 200 that starts with a step 202. Such executes, typically, as a subroutine in the CBQ traffic shaper 110 of FIG. 1. A step 204 decides whether an incoming packet has a recognized class. If so, a step 206 checks that class currently has available bandwidth. If yes, a step 208 sends that datapacket on to its destination without detaining it in a buffer. Step 208 also deducts the bandwidth used from the class' account, and updates other statistics. Step 208 returns to step 204 to process the next datapacket. Otherwise, a step 210 simply returns program control.

In general, recognized classes of datapackets will be accelerated through the system by virtue of increased bandwidth allocation. Datapackets with unrecognized classes are given lowest priority, and are stalled in buffers whenever guaranteed bandwidths are being disbursed under contracted-for user classes.

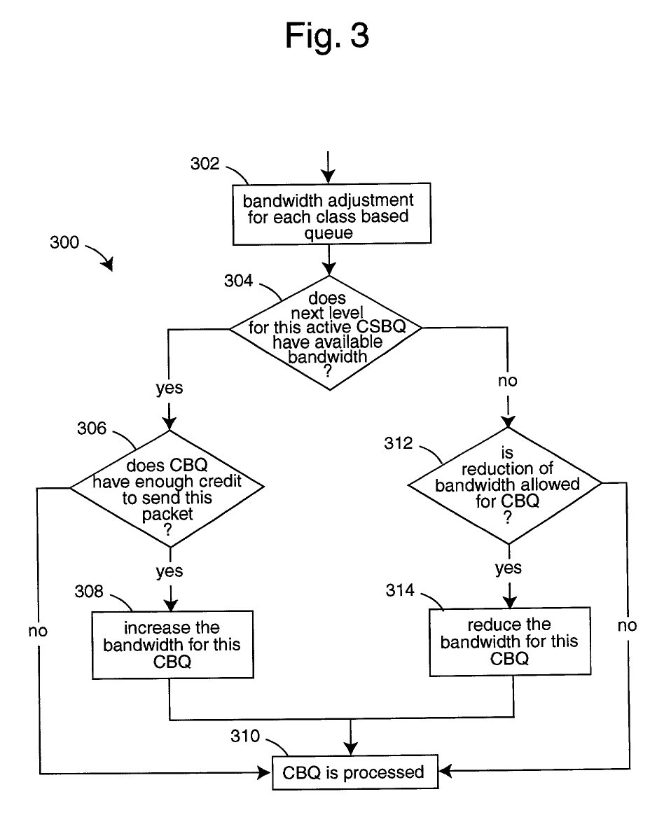

A bandwidth adjustment method 300 is represented by FIG. 3. It starts with a step 302. A step 304 decides if the next level for a current class-based queue (CBQ) has any available bandwidth that could be “borrowed”. If yes, a step 306 checks to see if the CBQ has enough “credit” to send the current datapacket. If yes, a step 308 temporarily increases the bandwidth ceiling for the CBQ and the current datapacket. A step 310 returns program control to the calling routine after the CBQ is processed. A step 312 is executed if there is no available bandwidth in the active CBQ. It checks to see if a reduction of bandwidth is allowed. If yes, a step 314 reduces the bandwidth.

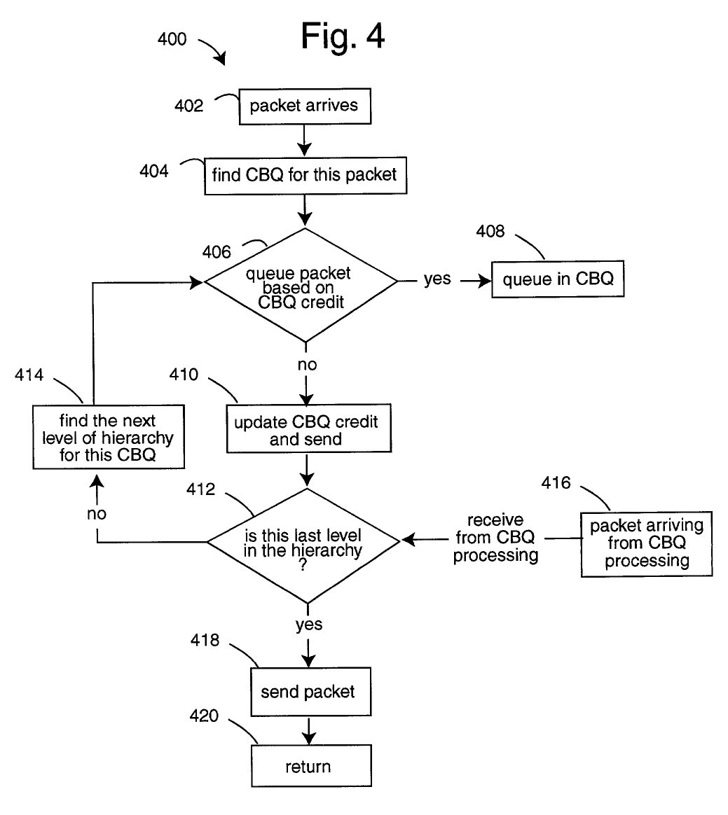

A packet process 400 is illustrated in FIG. 4 and is a method embodiment of the present invention. It begins with a step 402 when a datapacket arrives. A step 404 attempts to find a CBQ that is assigned to handle this particular class of datapacket. A step 406 checks to see if the datapacket should be queued based on CBQ credit. If yes, a step 408 queues the datapacket in an appropriate CBQ. Otherwise, a step 410 updates the CBQ credit and sends the datapacket. A step 412 checks to see if it is the last level in a hierarchy. If not, program control loops back through a step 414 that finds the next hierarchy level. A step 416 represents a return from a CBQ processing subroutine like that illustrated in FIG. 9. If the last level of the hierarchy is detected in step 412, then a step 418 sends the datapacket. A step 420 returns program control to the calling program.

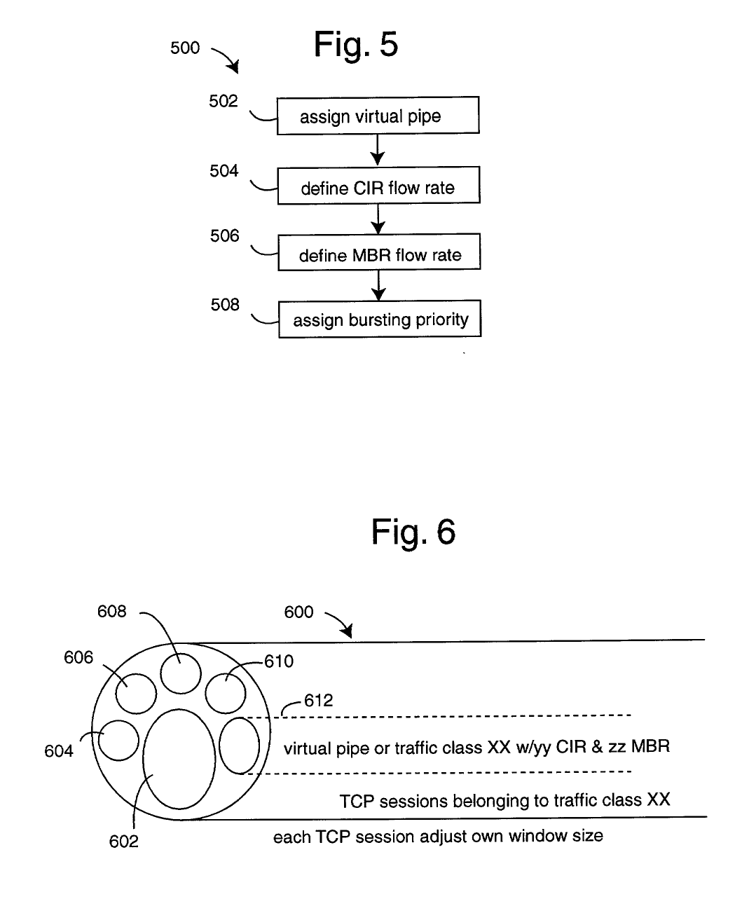

FIG. 5 represents a user setup program embodiment of the present invention, and is referred to herein by the general reference numeral 500. The program 500 includes a step 502 for assigning a virtual pipe. A step 504 defines the CIR flow rate. A step 506 defines the MBR flow rate. And, a step 508 assigns the bursting priority.

FIG. 6 represents how a physical fiberoptic cable 600 can be thought to consist of many constituent virtual pipes 602, 604, 606, 608, 610, and 612. These virtual pipes are, of course, not physically manifested as shown in the FIG. Each virtual pipe can be of different size, and each can freely vary in size dynamically over time according to user parameters, fees paid, classes of datapackets, bursts, available bandwidth, etc.

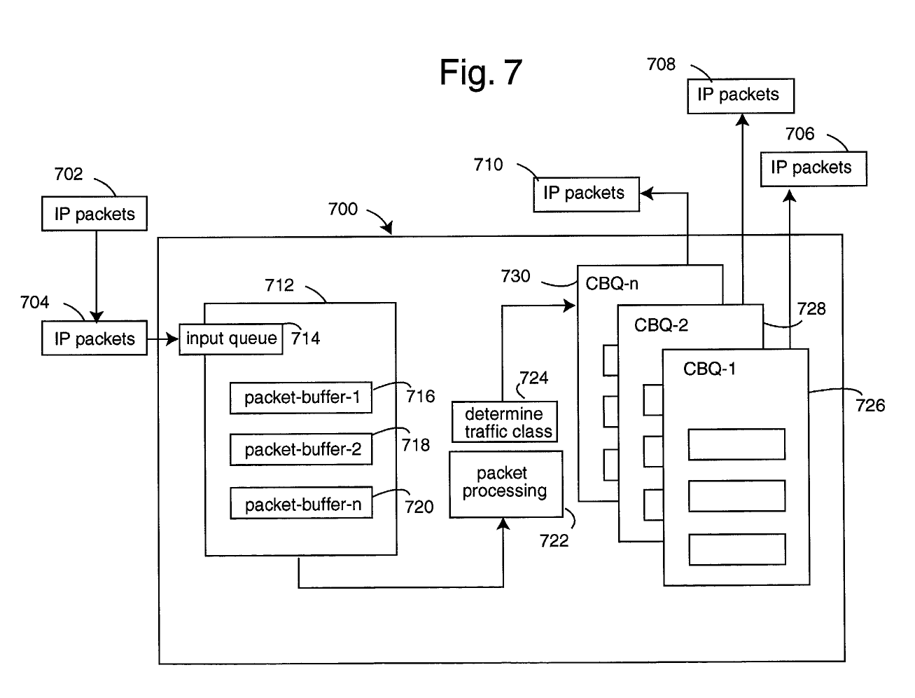

FIG. 7 illustrates a CBQ traffic shaper 700 in an embodiment of the present invention. The CBQ traffic shaper 700 receives an incoming stream of datapackets, e.g., 702 and 704. Such are typically transported with TCP/IP on a computer network like the Internet. Datapackets are output at controlled rates, e.g., as datapackets 706, 708, and 710. A typical CBQ traffic shaper 700 would have two mirror sides, one for incoming and one for outgoing for a full-duplex connection. Here in FIG. 7, only one side is shown and described to keep this disclosure simple and clear.

An IP-address/port-number classifier 712 has an input queue 714. It has several packet buffers, e.g., as represented by packet-buffers 716, 718, and 720. Each incoming datapacket is put in a buffer to wait for classification processing. A packet processor 722 and a traffic-class determining processor 724 distribute datapackets that have been classified and those that could not be classified into appropriate class-based queues (CBQ).

A collection of CBQs constitutes an automatic bandwidth manager (ABM). Such enforces the user service level agreement policies that attach to each class. Individual CBQs are represented in FIG. 7 by CBQ 726, 728, and 730. Each CBQ can be implemented with a first-in, first-out (FIFO) register that is clocked at the maximum allowable rate (bandwidth) for the corresponding class.

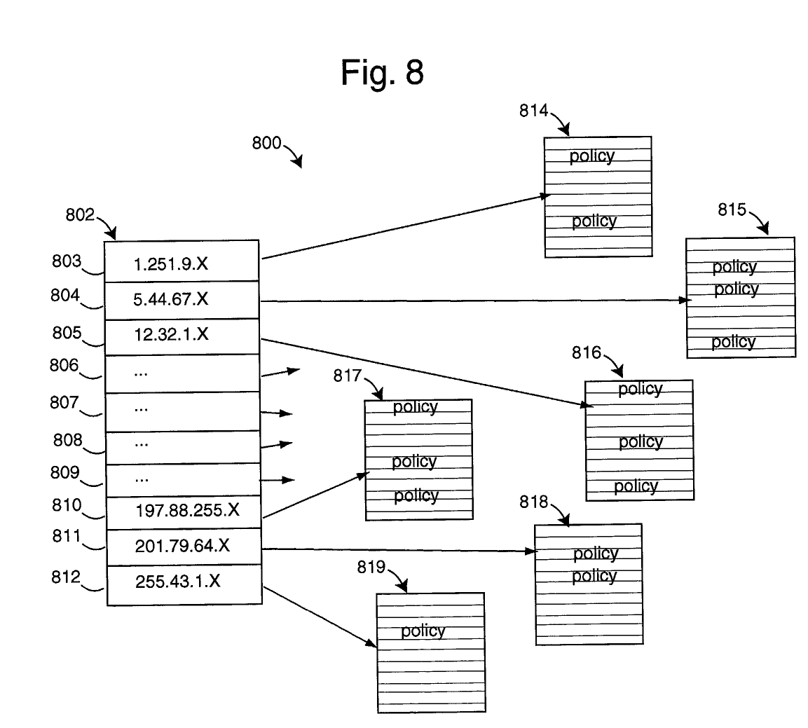

FIG. 8 represents a memory organization embodiment of the present invention which is referred to herein by the general reference numeral 800. Method embodiments of the present invention which are implemented in computer software truncate the least significant byte of all possible four-byte IP-addresses into their corresponding three-byte segment numbers. Any IP-address that is relevant to a particular policy has its segment number recorded into a sorted list 802. In a typical implementation, there will be about eighty such entries, all of which are represented by segment entries 803-812.

If a datapacket that needs to be classified has a corresponding segment entry 803-812, the truncated least significant byte is used to index into a policy lookup table 814-819. Each such policy lookup table 814-819 can store up to 256 policies for each sub-segment address. For example, if a datapacket to be classified has a segment address of “5.44.67”, the match will be found as entry 804 in sorted list 1402. A pointer in the entry 804 points to policy lookup table 815. The least significant byte of the datapacket IP-address is then used to index one location in table 815. That will return the policy identifier that such be used to handle the throughput of the datapacket. If the datapacket that needs to be classified does not have a corresponding segment entry 803-812, then a default classification and policy can be used.

The method related to FIG. 8 therefore uses far less memory than would otherwise be the case, and the policy fetch is much quicker. In this case, a simple two-step procedure.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A method for fetching bandwidth control information about a datapacket in a network that is associated with a source or destination IP-address of such datapacket, the method comprising the steps of:
parsing an IP-address from an information header in a datapacket;
truncating off a least significant portion of said IP-address to form a segment number;
searching for said segment number in at least one of an ordered list of segment numbers and a content-addressable memory (CAM);
pointing to a policy lookup table if a match occurs in the step of searching; and
indexing with said least significant portion of said IP-address into said policy lookup table to find a policy identification value.

2. The method of claim 1, further comprising the step of:
using said policy identification value to control a communication bandwidth afforded to the throughput of said datapacket.

3. The method of claim 1, further comprising the preliminary steps of:
associating said policy identification number with an IP-address in said network and recording such association in said ordered list of segment numbers and said policy lookup table.

4. A network, comprising:
a local group of network workstations and clients with a set of corresponding local IP-addresses, and that periodically access a wide area network (WAN);
at least one type of application program for executing packet exchanges that involve any of the local group;
a class-based queue (CBQ) traffic shaper disposed between the local group and said WAN, and providing for a variety of access bandwidths;
an IP-address/port-number classifier disposed within the CBQ traffic shaper, and providing for an identification of which application program transmitted or received a particular packet at any of the local group; and
an automatic bandwidth manager (ABM) disposed within the CBQ traffic shaper, and providing for a controlled delivery rate of each said particular packet that is dependent on the application-program type determined by the IP-address/port-number classifier;
wherein, bandwidth control information about a datapacket in the network is associated with a source or destination IP-address of such datapacket, and a processor provides for parsing an IP-address from an information header in a datapacket, truncating off a least significant portion of said IP-address to form a segment number, searching for said segment number in at least one of an ordered list of segment numbers and a content-addressable memory (CAM), pointing to a policy lookup table if a match occurs in the step of searching, and indexing with said least significant portion of said IP-address into said policy lookup table to find a policy identification value.

5. The network of claim 4, wherein:
the CBQ traffic shaper is configured such that a user service level agreement (SLA) policy is attached to each and every said local IP-address.

6. The network of claim 4, wherein:
the CBQ traffic shaper is configured so any SLA policy conflicts between local IP-address transfers are resolved with a lower-speed one of said conflicting policies taking precedence.

7. The network of claim 4, wherein:
the CBQ traffic shaper dynamically attaches SLA policies and readjusts the CBQ traffic shaper to allow an on-demand type of delivery to any of said local IP-addresses.

8. A computer network method, comprising the steps of:
dividing a plurality of datapackets into classes that include at least one class for packets exchanged over a computer network by a particular application program;
identifying which class each particular one of plurality of packets belongs to on said computer network;
controlling a delivery rate of an identified particular one of plurality of datapackets according to its classification;
parsing an IP-address from an information header in a datapacket;
truncating off a least significant portion of said IP-address to form a segment number;
searching for said segment number in an ordered list of segment numbers;
pointing to a policy lookup table if a match occurs in the step of searching; and
indexing with said least significant portion of said IP-address into said policy lookup table to find a policy identification value.
